(19) United States
(12) Patent Application Publication
(10) Pub. No.: US 2012/0305612 A1
(43) Pub. Date: Dec. 6, 2012

(54) Swing Arm Vehicle Accessory Mounting System

(76) Inventor: Cecil Ivan Bell, JR., Magnolia, TX (US)

(21) Appl. No.: 13/150,498

(22) Filed: Jun. 1, 2011

(51) Int. Cl. B60R 9/00

(52) U.S. Cl. 224/519

(57) ABSTRACT

A vehicle accessory mounting system allowing accessories to be carried external to the vehicle in a manner which allows them to be repositioned to grant access to the rear of the vehicle without dismounting the accessory load and while not occupying or restricting use of the vehicle's standard tow hitch connection point. The mounting system further comprises adjustment to allow the accessory's position to be adjusted up or down to prevent obstruction of view or wind drag, and to be position left or right to prevent obstruction of vehicle identification.

### BACKGROUND OF THE INVENTION

### Cross-Reference to Related Applications

Not Applicable.

### STATEMENT REGARDING FEDERALLY SPONSORED RESEARCH OR DEVELOPMENT

Not Applicable.

### BACKGROUND OF THE INVENTION

People often find it necessary to mount accessories on their vehicles. There are needs to carry items such as bicycles, coolers, wagons, tanks, etc which simply do not fit or should not be placed inside of a vehicle for a variety of reasons. Some items are dirty, they have the potential to leak, or they emit odors and the occupants just do not want to be inconvenienced by an item inside the vehicle. Sometimes the quantity of items to be transported is too large for the vehicle. Sometimes the items to be transported need to be on the outside of the vehicle for operational purposes, such as a seed spreader or a sprayer. Other times the items to be transported need to be outside just for the ease, access, and convenience of loading and unloading the vehicle.

### BRIEF DESCRIPTION OF THE DRAWINGS

FIG. 1 shows a rear view of a vehicle with a vehicle accessory mounting system in accordance with an exemplary embodiment of the invention.

FIG. 2 is a close up view of the vehicle accessory mounting system in accordance with an exemplary embodiment of the invention, illustrating additional detail above that shown in the previous view.

FIG. 3 shows the vehicle accessory mounting system in an open position in accordance with an exemplary embodiment of the invention.

### DETAILED DESCRIPTION OF THE PREFERRED EMBODIMENTS

The described vehicle accessory mounting assembly allows a vehicle to externally carry an accessory without impeding the vehicles other functions. The mounting assembly attaches to the vehicle's existing trailer hitch without occupying the hitch and preventing its use for other towing purposes. The mounting assembly allows a vehicle accessory to be swung to the side of a vehicle's rear hatch, door, or tailgate allowing access to such without removing the accessory or the mounting assembly from the vehicle. The mounting assembly described has an adjustable mounting plate to allow the height of the accessory being carried to be raised high enough to prevent interference with a trailer or other device connected to the towing hitch, or lowered to prevent and obstructed view, or cause unnecessary wind drag on the vehicle.

The vehicle accessory mounting assembly comprises a stable horizontal member which runs substantially parallel to the vehicles rear bumper and perpendicular to the center line of the vehicle. The vehicle accessory mounting assembly may mount to the left or right side of the hitch, but is preferably mounted to the side opposite the driver of the vehicle to allow the driver an easier time visually inspecting the device over the inside shoulder when driving. Further, doing so would allow the vehicle accessory to swing away from traffic when the vehicle was parked on the side of the street facing in the direction of traffic, as one should normally park in most jurisdictions.

The mounting assembly is secured to an existing standard square tube trailer mount in front of the hitch's rear facing ball joint. The mounting assembly may be permanently attached to the standard square tube trailer hitch by welding it securely to the tubing. In another embodiment the mounting assembly comprises a U-channel which slips around the square tubing of the trailer hitch and secures by compression or through bolt, or other means of preventing the U-channel from disengaging from the standard square tube trailer hitch's square tubing.

The stable horizontal member of the mounting assembly extends to one side of the trailer hitch to a distance approximately equal to half the vehicle's width. At this distal end, the stable horizontal member is pivotally joined to a swinging horizontal member such that the swinging horizontal member can rotate in a plane substantially parallel to the bottom of the vehicle. A swing stop is used to prevent the swinging horizontal member from over swinging such that it is prevented from swinging around and striking the side of the vehicle, or an adjacent vehicle.

An optional latching plate may be used to support the swinging horizontal member in the closed position, that is parallel to the rear bumper of the vehicle and reduce strain on the pivotal connection point. Such a latching plate may provide a mechanism for holding the swinging horizontal member in this closed position in a secured manner. Optionally, the two horizontal member may other locking mechanisms to secure them in the closed manner. One example may be, but is not limited to, the use of locking tabs on both the stable and swinging horizontal members with a locking pin or bolt passing through a hole in the locking tabs. In another embodiment, the horizontal members may have through holes where a locking pin may pass between the members securing them in a closed position.

In the preferred embodiment the swinging horizontal member is position on top of the stable horizontal member and a through pin is passed vertically down through the members near the end opposite the trailer hitch. In another embodiment the two members may be mounted side by side with a hinge connected between the members near the end opposite the trailer hitch. One skilled in the art would appreciate a number of ways in which the pivoting connection between the swinging horizontal member and the stable horizontal member may be accomplished.

In the preferred embodiment, the stable horizontal member is longer than the swinging horizontal member and the two are substantially aligned and joined pivotally at the end opposite the trailer hitch. This ensures the vertical riser is to one side of a center mounted license plate preventing obstruction of the plate as required in some jurisdictions. In another embodiment the swinging horizontal member may be even shorter such that the vehicle accessory is completely to one side of the vehicle's center line. In use of such an embodiment, a second vehicle accessory mounting assembly could be mounted on the opposite side of the standard square tube trailer hitch so that two vehicle accessories could be carried by a single vehicle. In another embodiment, the swinging horizontal member is comprised of multiple members which are telescopically connected to allow their length to be adjusted. In another embodiment the swinging horizontal member s the approximately the same length as the stable horizontal member so that the vertical riser is approximately centered on the vehicle's standard square tube trailer hitch thus adding extra support for larger loads.

The end of the swinging horizontal member opposite the pivotal joint connects to a vertical riser at the lower end of the vertical riser. This riser supports the vehicle accessory through the use of a universal mounting plate on the upper end or side of the vertical riser. In one embodiment the vertical riser is comprised of telescopically connected tubing allowing the length of the vertical riser, and thus the height of the vehicle accessory to be adjusted. This allows an accessory to be raised such that it does not interfere with a towed trailer, or other use of the standard square tube trailer hitch. Further, the adjustable riser allows the accessory to be lowered so that the accessory could be lowered to be out of the wind stream of the moving vehicle, thus reducing drag, or lowered so as not to hinder the driver's view out the back of the vehicle. In one embodiment, the vertical riser comprises a center square tube pipe and the universal mounting plate comprises angle brackets positioned such that they meet the sides of the square tube, both having a plurality of spaced through holes for allowing a pin or bolt to pass thorough. One skilled in the art would appreciate that there are other methods available for configuring the universal mounting plate and the vertical riser such that the height of the accessory can be adjusted.

The top of the vertical riser or the upper side of the vertical riser contains a universal mounting plate. In one embodiment the universal mounting plate is a rectangular plate with a plurality of through holes for mounting the vehicle accessory. In another embodiment the universal mounting plate may be a hook, catch, channel, or post designed to connect with a wide variety of vehicle accessories. One skilled in the art would appreciate that a number of mounting devices would be applicable to the invention as described and that many of them may be attachable to the vertical riser to aid in securing the vehicle accessory. One skilled in the art would also appreciate that an appropriate vehicle accessory may not require a separate mounting plate and may be directly attached to the riser.

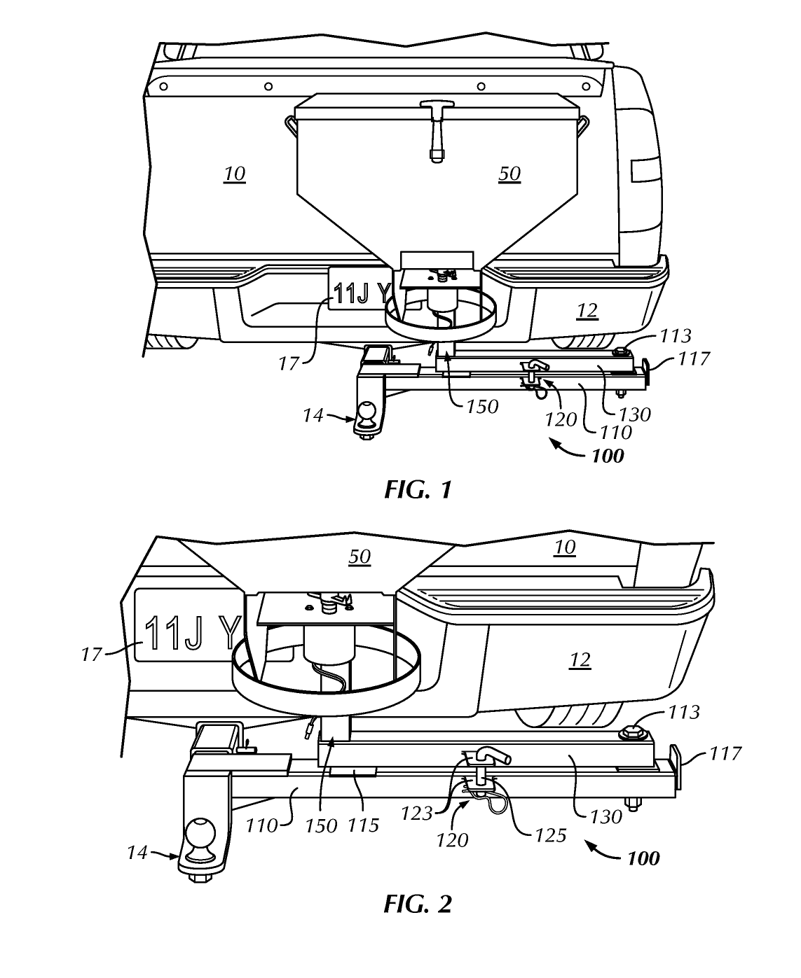

FIG. 1 shows a rear view of a vehicle with a vehicle accessory mounting system in accordance with an exemplary embodiment of the invention. The vehicle (10), in the example shown has a vehicle accessory (50) mounted near the back bumper (12) which is supported by the standard square tube trailer hitch (14). This accessory is mounted to be offset from the center of the vehicle (10) such that the license plate (17) remains visible.

The vehicle accessory mounting system (100) comprises a stable horizontal member (110) which is connected at one end to the vehicle's (10) standard square tube trailer hitch (14) in such a manner that the ball hitch is not occupied and may still function for its original intended use of connecting a trailer or other tow behind vehicle companion. The stable horizontal member (110) which is connected on one end to the standard square tube trailer hitch (14) is pivotally connected (113) at the distal end to a swinging horizontal member (130). When properly configured for transport, a locking mechanism (120) ensures the swinging horizontal member (130) remains parallel to the stable horizontal member (110) to prevent the vehicle accessory (50) from rotating out to come in contact with the swing stop (117) in an unsecured manner. From this view, the vehicle accessory (50) shown, which is an animal feeder, obstructs all but the bottom of the vertical member (150) which supports it, and is mounted on the end of the swinging horizontal member's (130) end distal the pivoting connection point (113).

FIG. 2 is a close-up view of the vehicle accessory mounting system in accordance with an exemplary embodiment of the invention, illustrating additional detail above that shown in the previous view. In this close-up view the vehicle (10) with its bumper (12), license plate (17), and standard square tube trailer hitch (14) are again shown. The vehicle accessory (50) is again supported by a vehicle accessory mounted system (100) manufactured in accordance with an exemplary embodiment of the invention.

In the diagram one can see the stable horizontal member (110) which runs parallel to the vehicle's bumper (12) and parallel to the plane of the vehicle's underside between the standard square tube trailer hitch (14) and the pivotal connection point (113). The swing stop (117) is illustrated as a plate (117) at the end of the stable horizontal member (130) which would prevent the swinging horizontal member (130) from swinging on the pivotal connection point (113) beyond approximately one-hundred seventy degrees (170°) from the closed position as established by the latching plate (115). One skilled in the art would appreciate that other configurations would be available to accomplish this swing stop, including but not limited to a chain or cable, a hinge, a gas piston, etc. The purpose is to allow the swinging member to pivot such that the vehicle accessory (50) is positioned to one side of the rear of the vehicle allowing access to the vehicle's (10) tail gate, trunk, hatch back, etc. without the need to remove the vehicle accessory from the vehicle.

Also, this view shows in more detail the locking mechanism (120) which is comprised of two locking tabs (123) connected to the stable horizontal member (110) and the swinging horizontal member (130) and joined in a locking fashion by a locking pin (125) which may optionally be secured through a cotter pin or lock. One skilled in the art would appreciate that a locking pin may be substituted for with a lock, or a cable, or some other form of latch. Further one skilled in the art would appreciate that the holes through the stable (110) and swinging (130) horizontal members may be substituted for the locking plates such that the locking pin passes through the horizontal members (110, 130). One skilled in the art would also appreciate that the latching plate (115) and the locking mechanism (120) could be incorporated into a single unit.

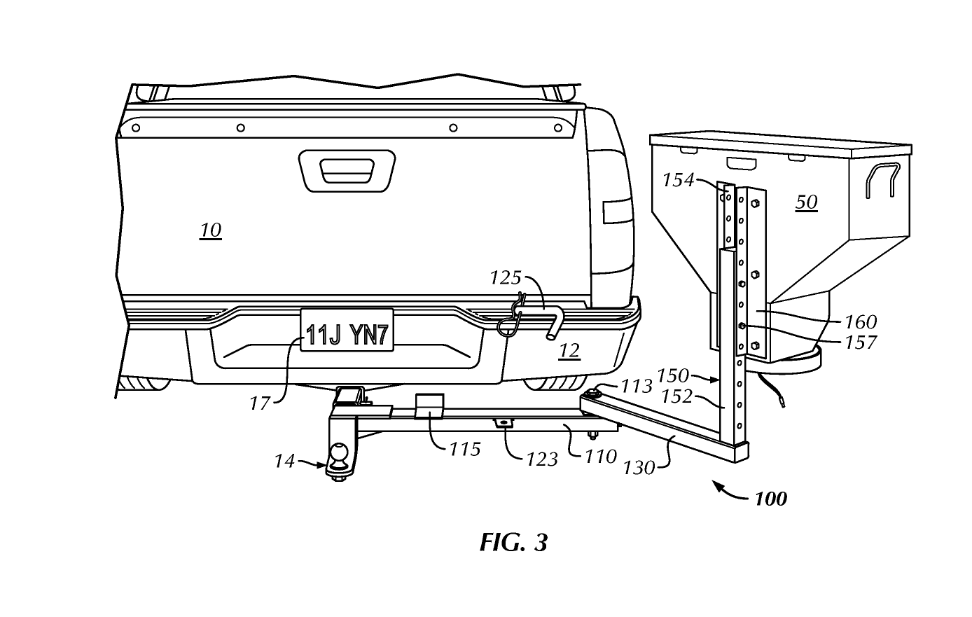

FIG. 3 shows the vehicle accessory mounting system in an open position in accordance with an exemplary embodiment of the invention. Here the locking pin (125) has been removed from the locking tabs (123) so the vehicle accessory (50) can be pivoted to one side of the vehicle's (10) rear allowing access to, in this case, a tail gate.

In this view the back of the vehicle accessory (50) is clearly visible and one can gain a better understanding of how the vehicle accessory (50) is secured to the vertical member (150). The embodiment illustrated shows a two part universal mounting plate (160) comprised of dual opposing “L” shaped sections which are mounted on the vehicle accessory (50). Together, the L-shaped sections comprise the upper riser arm (154) which is coupled to the lower riser arm (152) through a riser height adjustment (157) shown here as a series of mating holes in the upper and lower arms which are aligned and secured with a bolt or locking pin.

One skilled in the art would appreciate that in an alternative embodiment the universal mounting plate (160) could comprise a single plate with tabs projecting perpendicular to the plate, running vertically and aligning with the side of the riser arm such that the universal mounting plate (160) and the upper riser arm (154) may be a single unit. One skilled in the art would also understand that various other configurations could be used to achieve the height adjustment mechanism's (157) functionality. Including, but not limited to telescopically aligned tubing with a means of securing at various heights. Those means include but are not limited to, through-hole bolting or pinning, treaded connections, clamping connections, ratcheting connections, hydraulic or gas rams, etc. In another embodiment, the upper riser arm may be pivotally connected to the top of the vertical riser arm such that it can be secured in a position ranging anywhere from parallel to the vertical riser arm, to perpendicular to the vertical riser arm.

In an alternative embodiment, the vertical member may be rotationally connected to the swinging horizontal member so that it can be folded down from the perpendicular alignment illustrated in the drawings to a parallel alignment for stowage. In another embodiment, the horizontal members may comprise two telescopically connected portions which allows the device to be adjusted for different sized vehicles.

In another embodiment, the vehicle accessory mounting system may be temporarily secured to the standard square tube trailer hitch. Such temporary mounting may be accomplished by bolting compression plates to the top and bottom of the square tube, or by using through bolts to secure the device to the square tubing. In another embodiment, a secondary tube may be permanently connected to either side of the square tubing of the trailer hitch to which the stable horizontal member may telescopically connect.

In another embodiment, the vehicle accessory mounting system may be implemented in a plurality such that there is a vehicle accessory mounted to either side of the trailer hitch, each pivoting out to their respective sides to allow access to the rear of the vehicle. In such a manner, the torque load on the trailer hitch would be countered. In another embodiment, the vehicle accessory mounting system may further comprise a counter weight on the other side of the vehicle hitch to counter rotational torque on the hitch.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A vehicle accessory mounting assembly comprising;
a stable horizontal member mounted to a vehicle at one end, parallel to the vehicle's rear bumper;
the distal end pivotally connected to a swinging horizontal member; and
the distal end of the swinging member fixedly mounted to the lower end of a vertical riser.

2. A vehicle accessory mounting assembly, as described in claim 1 wherein the stable horizontal member is mounted to the approximate middle of the vehicle's rear bumper.

3. A vehicle accessory mounting assembly, as described in claim 2 wherein the stable horizontal member is mounted to the vehicle's trailer hitch.

4. A vehicle accessory mounting assembly, as described in claim 3 wherein such mounting does not interfere with the use of the vehicle's trailer hitch for connecting a trailer.

5. A vehicle accessory mounting assembly, as described in claim 1 wherein the stable horizontal member and the swinging horizontal member further comprise a locking mechanism between the members to prevent the swinging allowed by the pivotal connection between the members.

6. A vehicle accessory mounting assembly, as described in claim 5 wherein the locking mechanism comprises a pin passed through holes in tabs connected to the horizontal members or through the horizontal members.

7. A vehicle accessory mounting assembly, as described in claim 1 wherein the vertical riser's upper end comprises a universal mounting plate.

8. A vehicle accessory mounting assembly, as described in claim 7 wherein the universal mounting plate has a plurality of through holes.

9. A vehicle accessory mounting assembly, as described in claim 1 wherein the swinging horizontal member is shorter than the stable horizontal member such that the vertical riser does not obscure a center mounted license plate on the vehicle.

10. A vehicle accessory mounting assembly, as described in claim 1 wherein the pivotal connection between the stable horizontal member and the swinging horizontal member is a pin passing through both members allowing the swinging member to swing away from the stable member through a plane substantially parallel to the bottom of the vehicle.

11. A vehicle accessory mounting assembly, as described in claim 1 wherein the plane is angled above parallel to the bottom of the vehicle such that the swinging member is aided by gravity in returning to the position of parallel with the stable member.

12. A vehicle accessory mounting assembly, as described in claim 10 wherein the pivotal connection further comprises a stop point preventing rotation beyond a specific point.

13. A vehicle accessory mounting assembly, as described in claim 11 wherein the specific point is greater than seventy degrees)(70°).

14. A vehicle accessory mounting assembly, as described in claim 11 wherein the specific point is less than two hundred seventy degrees)(270°).

15. A vehicle accessory mounting assembly, as described in claim 3 wherein mounting to the trailer hitch comprises securing to a standard square-tube trailer hitch.

16. A vehicle accessory mounting assembly, as described in claim 15 wherein the securing to a standard square-tube trailer hitch is done in front of the hitch ball, thus leaving the hitch ball unobstructed.

17. A vehicle accessory mounting assembly, as described in claim 1 wherein the vertical riser is of an adjustable height.

18. A vehicle accessory mounting assembly, as described in claim 1 wherein the assembly is composed of metal.

19. A vehicle accessory mounting assembly, as described in claim 1 wherein the assembly is composed of carbon reinforced fiberglass.

20. A vehicle accessory mounting assembly, as described in claim 1 wherein the assembly is composed of plastic.
